(19) United States
(12) Patent Application Publication
(10) Pub. No.: US 2020/0333636 A1
(43) Pub. Date: Oct. 22, 2020

(54) Eyewear and Electronic Device

(71) Applicant: BOE Technology Group Co., Ltd., Beijing (CN)

(72) Inventors: Yan Ren, Beijing (CN); Zifeng Wang, Beijing (CN); Lei Cao, Beijing (CN); Junmin Sun, Beijing (CN)

(73) Assignee: BOE Technology Group Co., Ltd., Beijing (CN)

(21) Appl. No.: 16/756,212

(22) PCT Filed: Dec. 11, 2018
(86) PCT No.: PCT/CN2018/120320

§ 371 Date: Apr. 15, 2020

(30) Foreign Application Priority Data
Apr. 24, 2018 (CN) 201820596415.3

(51) Int. Cl. G02C 13/00; G02C 7/08; G02C 11/00; B08B 1/00

(52) U.S. Cl. CPC G02C 13/006; B08B 1/002; G02C 11/10; G02C 7/086

(57) ABSTRACT

An eyewear includes a frame capable of being mounted with at least one lens, and a driving mechanism. A lower part of the frame is configured as a use position allowing the at least one lens to be in a use state, an upper part of the frame is configured as a storage position allowing the at least one lens to be in a storage state, and the driving mechanism is configured to drive the at least one lens to move between the use position and the storage position.

The present application claims priority to Chinese patent application No. 201820596415.3, filed on Apr. 24, 2018, the entire disclosure of which is incorporated herein by reference as part of the present application.

### TECHNICAL FIELD

Embodiments of the present disclosure relate to an eyewear and an electronic device.

### BACKGROUND

An eyewear typically includes structures such as a frame and lenses. For example, according to functionality, the eyewear may be roughly classified into various types, such as vision correction glasses (for example, glasses for myopia, glasses for hyperopia, glasses for astigmatism, etc.), safety glasses, 3D glasses, and the like.

At present, the lenses of the eyewear are usually fixed on the frame, so that the lenses cannot be moved. For example, in some specific cases, a user needs to wear safety glasses or 3D glasses to perform certain professional operations. In the case where a foreign object is attached to the lenses to affect the user's normal use, the user needs to stop working to replace or clean the eyewear attached with the foreign object, which may distract the user's attention and affect the user's work efficiency.

### SUMMARY

At least one embodiment of the present disclosure provides an eyewear, which comprises a frame capable of being mounted with at least one lens, and a driving mechanism. A lower part of the frame is configured as a use position allowing the at least one lens to be in a use state, an upper part of the frame is configured as a storage position allowing the at least one lens to be in a storage state, and the driving mechanism is configured to drive the at least one lens to move between the use position and the storage position.

In an embodiment of the present disclosure, the eyewear further comprises an eyewear cover, the eyewear cover is on the upper part of the frame and forms a storage box having a storage space together with the frame, and the storage box is configured to accommodate the at least one lens at the storage position.

In an embodiment of the present disclosure, the eyewear further comprises a cleaning mechanism in the storage box, and the cleaning mechanism is configured to clean the at least one lens accommodated in the storage box.

In an embodiment of the present disclosure, the cleaning mechanism comprises a cleaning brush and a cleaning brush putter. The cleaning brush putter is configured to enable the cleaning brush to be in a retracted state, or to be in an extended state to perform a cleaning operation, and the cleaning brush is configured to clean a surface of the at least one lens accommodated in the storage box.

In an embodiment of the present disclosure, a first side of the eyewear cover is provided with a cleaning motion mechanism, and the cleaning mechanism is configured to reciprocate on the cleaning motion mechanism.

In an embodiment of the present disclosure, the cleaning motion mechanism comprises a first guide rail and a first driving device, and the first driving device is configured to drive the cleaning brush and the cleaning brush putter to reciprocate on the first guide rail.

In an embodiment of the present disclosure, the eyewear further comprises a detection device, and the detection device is configured to detect whether there is a foreign object on a surface of the at least one lens.

In an embodiment of the present disclosure, the detection device comprises an infrared detection device.

In an embodiment of the present disclosure, the detection device comprises a camera.

In an embodiment of the present disclosure, the driving mechanism comprises at least one second guide rail and a second driving device, the at least one lens is able to slide along the second guide rail to move from the use position to the storage position or from the storage position to the use position, and the second driving device is configured to drive the at least one lens to slide on the second guide rail.

In an embodiment of the present disclosure, the driving mechanism comprises an association mechanism, the frame is mounted with two lenses, and the association mechanism is configured to relatively and associatively drive the two lenses, which are connected to the association mechanism, so as to enable the two lenses to perform a relative movement.

In an embodiment of the present disclosure, the association mechanism comprises a linear reciprocating motion mechanism.

In an embodiment of the present disclosure, the eyewear further comprises a control device, and the control device is configured to control the driving mechanism to move the at least one lens.

In an embodiment of the present disclosure, the frame is mounted with at least two lenses.

At least one embodiment of the present disclosure further provides an electronic device, which comprises the above-mentioned eyewear.

### BRIEF DESCRIPTION OF THE DRAWINGS

In order to clearly illustrate the technical solution of the embodiments of the present disclosure, the drawings of the embodiments will be briefly described in the following. It is obvious that the described drawings in the following are only related to some embodiments of the present disclosure and thus are not limitative of the present disclosure.

FIG. 1 is a schematic structural diagram of an eyewear according to an embodiment of the present disclosure;

FIG. 2 is a schematic structural diagram of an eyewear according to another embodiment of the present disclosure;

FIG. 3A is a schematic structural diagram of a driving mechanism of an eyewear according to an embodiment of the present disclosure;

FIG. 3B is a schematic structural diagram of a driving mechanism of an eyewear according to another embodiment of the present disclosure;

FIG. 3C is a schematic structural diagram of a driving mechanism of an eyewear according to still another embodiment of the present disclosure;

FIG. 4 is a schematic structural diagram of a cleaning motion mechanism and a cleaning mechanism of an eyewear according to an embodiment of the present disclosure;

FIG. 5 is a schematic structural diagram of an eyewear according to still another embodiment of the present disclosure; and

FIG. 6 is a flowchart of a method for operating an eyewear according to an embodiment of the present disclosure.

### DETAILED DESCRIPTION

In order to clearly illustrate the technical solution of the embodiments of the present disclosure, the drawings of the embodiments will be briefly described in the following. It is obvious that the described drawings in the following are only related to some embodiments of the present disclosure and thus are not limitative of the present disclosure.

Unless otherwise defined, all the technical and scientific terms used herein have the same meanings as commonly understood by one of ordinary skill in the art to which the present disclosure belongs. The terms “first,” “second,” etc., which are used in the description and the claims of the present application for disclosure, are not intended to indicate any sequence, amount or importance, but distinguish various components. Also, the terms such as “a,” “an,” etc., are not intended to limit the amount, but indicate the existence of at least one. The terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect”, “connected”, “coupled”, etc., are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly.

At present, for example, lenses of 3D glasses are usually fixed on a frame and cannot be moved. In the medical field, in order to improve the accuracy of some surgical operations, for example, 3D display technology may be used to synchronously display the surgical screen on the display screen. In this case, the doctor usually needs to wear 3D glasses to feel the depth information of the received image and generate stereoscopic vision, which can help the doctor to perform the surgical operations more accurately. In the case where a foreign object is attached on the lenses, the doctor cannot clearly observe the image on the display screen through the glasses. The doctor usually needs to stop working to replace or clean the glasses attached with the foreign object. In this way, the doctor's attention cannot be concentrated, which affects the work efficiency.

At least one embodiment of the present disclosure provides an eyewear, and the eyewear includes a frame capable of being mounted with at least one lens, and a driving mechanism. A lower part of the frame is configured as a use position allowing the at least one lens to be in a use state, an upper part of the frame is configured as a storage position allowing the at least one lens to be in a storage state, and the driving mechanism is configured to drive the at least one lens to move between the use position and the storage position.

In an embodiment of the present disclosure, the eyewear includes at least one lens, and the driving mechanism can drive the at least one lens to move between the use position and the storage position. The eyewear may further be provided with a cleaning mechanism as required, which may be provided on the upper part of the frame to clean the lens located in the storage position. The eyewear can automatically replace the dirty lens and clean the dirty lens, thereby preventing the user from pausing the work being processed and performing the operation of replacing or cleaning the lens, so that the user's attention is not easily distracted and the work efficiency of the user is improved.

The disclosure is described below with reference to several embodiments. In order to keep the description of the present disclosure clear and concise, detailed descriptions of known functions and known components may be omitted. In the case where any component of an embodiment of the present disclosure appears in more than one drawing, the component may be represented by the same reference numeral in each drawing.

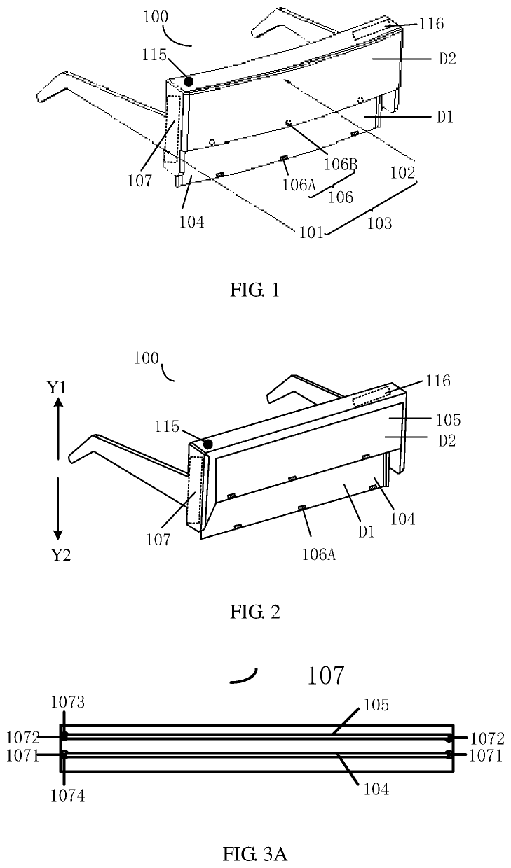

At least one embodiment of the present disclosure provides an eyewear 100, for example, the eyewear 100 may be any suitable type of glasses, such as vision correction glasses (glasses for myopia, glasses for hyperopia, glasses for astigmatism), safety glasses, and 3D glasses, e.g., shutter glasses, polarized glasses, red-cyan glasses, and the like, and the present disclosure does not limit the type of the eyewear 100. FIG. 1 and FIG. 2 are schematic structural diagrams of an eyewear 100 according to an embodiment of the present disclosure. As illustrated in FIG. 1 and FIG. 2, the eyewear 100 includes a frame 101 capable of being mounted with at least one lens, and a driving mechanism 107. A lower part of the frame 101 is configured as a use position D1 allowing the at least one lens to be in a use state, an upper part of the frame 101 is configured as a storage position D2 allowing the at least one lens to be in a storage state, and the driving mechanism 107 is configured to drive the at least one lens to move between the use position D1 and the storage position D2. For example, the eyewear 100 may include one lens, two lenses, or multiple lenses, and the number of the lenses and the type of the driving mechanism are not limited in the present disclosure. The following is described by taking the embodiment in which the eyewear 100, as illustrated in FIG. 2, includes two lenses as an example.

As illustrated in FIG. 2, the eyewear 100 includes a first lens 104 and a second lens 105. Two sides of the first lens 104 and two sides of the second lens 105 are respectively fixed on the driving mechanism 107, and for example, may move up and down (longitudinally) along a guide rail of the driving mechanism 107. For example, the first lens 104 may be located at the lower part of the frame 101, that is, located at the use position D1, or may be located at the upper part of the frame 101, that is, located at the storage position D2, and the second lens 105 may be correspondingly located at the storage position D2 or the use position D1 of the frame 101. It should be noted that, in the present embodiment, the direction “up” refers to the direction indicated by the solid line arrow Y1 illustrated in FIG. 2, and the direction “down” refers to the direction indicated by the solid line arrow Y2 illustrated in FIG. 2. For example, as illustrated in FIG. 2, the use position D1 and the storage position D2 are relative to each other, the storage position D2 is located in the direction indicated by the arrow Y1, and the use position D1 is located in the direction indicated by the arrow Y2, that is, the storage position D2 is located above the use position D1.

For example, as illustrated in FIG. 1, in the embodiments of the present disclosure, the eyewear 100 further includes an eyewear cover 102, the eyewear cover 102 is on the upper part of the frame 101 and forms a storage box 103 having a storage space together with the frame 101, and the storage box 103 is configured to accommodate the first lens 104 and/or the second lens 105 at the storage position. For example, the eyewear cover 102 may be fixed on the frame 101 so as to be integrally formed with the frame 101 to form the storage box 103; or the eyewear cover 102 and the frame 101 may be independent structures, and the eyewear cover 102 may be nested and mounted on the frame 101 to form the storage box 103 together with the frame 101. For example, the eyewear cover 102 may be transparent or opaque.

In an embodiment of the present disclosure, the first lens 104 may move from the use position D1 to the storage position D2, or move from the storage position D2 to the use position D1; and the second lens 105 may move from the storage position D2 to the use position D1, or move from the use position D1 to the storage position D2. The movement of the first lens 104 and the second lens 105 may be realized in various ways. For example, in an example, the driving mechanism 107 is configured to independently drive the first lens 104 and the second lens 105 to enable the first lens 104 and the second lens 105 to move to corresponding positions, respectively. For example, in an example, the driving mechanism 107 includes at least a pair of second guide rails and a second driving device.

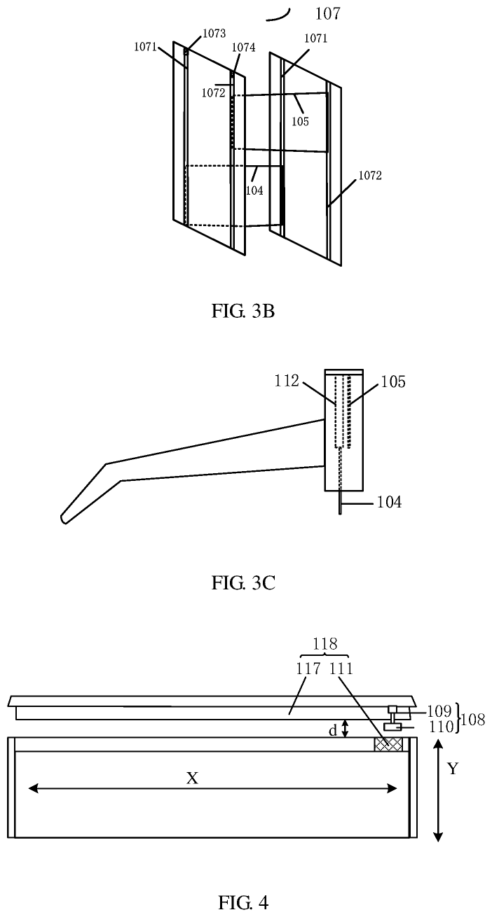

For example, FIG. 3A is a top view of the driving mechanism 107 according to the present example, and FIG. 3B is a perspective view of the driving mechanism 107 according to the present example. As illustrated in FIG. 3A and FIG. 3B, the driving mechanism 107 includes two second guide rails and two second driving devices. The two second guide rails are, for example, a second guide rail 1071 and a second guide rail 1072, respectively, and the two second driving devices are, for example, a second driving device 1073 and a second driving device 1074, respectively. For example, the second driving device 1073 may be disposed on the second guide rail 1071, and the second driving device 1074 may be disposed on the second guide rail 1072. For example, as illustrated in FIG. 3A and FIG. 3B, the second driving device 1073 can drive the first lens 104 to slide along the second guide rail 1071 so that the first lens 104 can move from the use position D1 to the storage position D2; and the second driving device 1074 can drive the second lens 105 to slide along the second rail 1072 so that the second lens 105 can move from the storage position D2 to the use position D1.

For example, as illustrated in FIG. 3A and FIG. 3B, the second guide rail 1071 and the second guide rail 1072 are fixed side by side on the longitudinal edge of the frame 101. For example, various combination ways can be adopted to combine the lenses and the guide rails. For example, the side edges of the first lens 104 and the second lens 105 may be respectively embedded in the corresponding guide rails so as to slide along the guide rails. For example, in the case where the driving mechanism 107 receives an instruction indicating that the first lens 104 needs to move from the use position D1 to the storage position D2, the second driving device 1073 starts to operate to drive the first lens 104 to slide along the second guide rail 1071, so that the first lens 104 can move from the use position D1 to the storage position D2; and in the case where the driving mechanism 107 receives an instruction indicating that the second lens 105 needs to move from the storage position D2 to the use position D1, the second driving device 1074 starts to operate to drive the second lens 105 slide along the second guide rail 1072, so that the second lens 105 can move from the storage position D2 to the use position D1. The second driving device 1073 and the second driving device 1074 may be, for example, motors, such as stepper motors, servo motors, and the like, which is not limited in the present disclosure. The present embodiment is described by taking that the second driving device 1073 and the second driving device 1074 are motors as an example.

For example, the rotations output by the second driving device 1073 and the second driving device 1074 (for example, the motors) may be converted into linear motions of the first lens 104 and the second lens 105 through various appropriate motion conversion structures. In this case, the second driving device 1074 corresponding to the second lens 105 is described as an example. For example, in an example, a combination of a slider and a lead screw may be adopted. The slider is provided on the lead screw and is connected to the lead screw by a thread. In addition, the slider is further fixedly connected to the second lens 105. When the output shaft of the motor, which serves as the second driving device 1074, starts to rotate, the lead screw is driven to rotate, and the slider can move up and down (for example, perform reciprocating motion) along the lead screw. For example, because the second lens 105 is connected to the slider, when the slider moves up and down along the lead screw, the second lens 105 moves with the slider in the same direction, so as to move from the storage position D2 to the use position D1 or from the use position D1 to the storage position D2.

For example, in another example, as illustrated in FIG. 3C, the driving mechanism 107 further includes, for example, an association mechanism 112, and the association mechanism 112 is configured to relatively and associatively drive the first lens 104 and the second lens 105, which are connected to the association mechanism 112, so as to enable the first lens 104 and the second lens 105 to perform a relative movement. For example, as illustrated in FIG. 3C, when the association mechanism 112 allows the second lens 105 to move from the storage position D2 to the use position D1, under the driving action of the association mechanism 112, the first lens 104 correspondingly moves from the use position D1 to the storage position D2. For example, in an example, the association mechanism 112 includes a linear reciprocating motion mechanism, such as a linkage, two terminals of which are respectively connected to the first lens 104 and the second lens 105, so that the first lens 104 and the second lens 105 are simultaneously driven to move relative to each other.

For example, as illustrated in FIG. 1 and FIG. 2, in an example, the eyewear further includes structures such as a control device 116, a power source 115, a detection device 106, and the like. For example, the detection device 106 includes structures such as a first detection device 106A, a second detection device 106B, and the like. The power source 115 is, for example, an external power interface or a built-in power source (for example, a primary battery or a secondary battery), and may be configured to supply power to the control device 116, the driving mechanism 107, and the like. The control device 116 may be, for example, various devices with control processing functions, such as a central processing unit (CPU), a programmable logic controller (PLC), a single-chip microcomputer, and the like. The central processing unit may be of various types, for example, X86 or ARM architecture. For example, the control device 116 is respectively in signal connection with the driving mechanism 107, a cleaning mechanism 108, the first detection device 106A, the second detection device 106B and the like by using, for example, a bus or the like, and sends and receives corresponding control signals and performs data processing, such as image processing, video processing, etc., which ensures that the eyewear 100 can realize functions such as automatic lenses replacement and cleaning of dirty lenses. The structures such as the cleaning mechanism 108, the second detection device 106B, and the like are described later in the present disclosure. For example, in the present embodiment, the eyewear 100 may further include a memory, and for example, the memory may include a non-volatile memory, such as one or more disk storage devices, a flash memory device, or other non-volatile solid-state storage devices.

For example, in order to achieve a better experience and automatic control, as illustrated in FIG. 1 and FIG. 2, in an example, the first detection device 106A is provided, at the use position D1 corresponding to the lenses, on the frame 101; or in another example, the first detection device 106A is provided on the first lens 104 and the second lens 105, and the first detection device 106A is configured to continuously detect whether a foreign object exists on the surface of the first lens 104 or the second lens 105 which is at the use position D1. It should be noted that the foreign objects here include, but are not limited to, debris, dust, particles, blood stains, smudges, fingerprints, droplets and other objects. The object on the lens may be considered as the foreign object as long as the object on the lens affects the normal use of the user or has adverse effects on the use effect of the user. For example, the first detection device 106A includes any suitable detection device such as an infrared detection device, a camera, or the like. For example, the infrared detection device includes a pyroelectric detection device or a photoelectric detection device. The infrared detection device converts the detected temperature signal or optical signal into an electrical signal and sends the electrical signal to, for example, the control device 116, and the control device 116 performs signal recognition processing on the electrical signal and outputs a corresponding instruction or the like. The camera includes, for example, an image acquisition unit such as a complementary metal oxide semiconductor (CMOS) sensor, a charge coupled device (CCD) sensor, or the like, and the captured image is sent to, for example, the control device 116 for image processing, recognition, and the like.

For example, as illustrated in FIG. 4, the eyewear 100 further includes structures such as a cleaning mechanism 108, a cleaning motion mechanism 118, and the like. The cleaning mechanism 108 is in the eyewear cover 102 and is configured to clean the first lens 104 or the second lens 105 accommodated in the storage box 103. As illustrated in FIG. 4, in an example, the cleaning mechanism 108 includes a cleaning brush putter 109 and a cleaning brush 110. The cleaning brush putter 109 is configured to enable the cleaning brush 110 to be in a retracted state, or to be in an extended state to perform a cleaning operation. The cleaning brush 110 is configured to clean the foreign object on the surface of the lenses accommodated in the storage box 103. The cleaning brush 110 may include, for example, a hairbrush, flannelette, and the like. For example, the cleaning motion mechanism 118 is disposed on a first side of the eyewear cover 102, and the first side may be, for example, a side, away from the use position D1, of the eyewear cover 102. The cleaning motion mechanism 118 includes a first guide rail 117 and a first driving device 111. The first driving device 111 is configured to drive the cleaning brush 110 and the cleaning brush putter 109 to reciprocate along the X direction in the first guide rail 117. In another example, the first driving device 111 and the second driving device 1073 (1074) may share the same motor, and the rotation of the motor is output through a clutch structure to drive the lenses and the cleaning brush putter 109, respectively.

For example, as illustrated in FIG. 1 and FIG. 2, in an embodiment of the present disclosure, the eyewear 100 further includes a second detection device 106B. For example, the second detection device 106B is disposed at the storage position D2 in the frame 101. The second detection device 106B is configured to detect the distance d in the Y direction between the cleaning brush 110 and the lenses in the storage box, and output the detection result to the control device 116. The control device 116 adjusts the distance between the lenses in the storage box and the cleaning brush 110 according to the detection result, so that the cleaning brush 110 can clean the lenses in the storage box. For example, the second detection device 106B may include any suitable detection device such as an infrared detection device, a camera, or the like. The infrared detection device includes, for example, a pyroelectric detection device or a photoelectric detection device. The camera includes, for example, a complementary metal oxide semiconductor (CMOS) sensor, a charge coupled device (CCD) sensor, or the like.

For example, the process of automatically replacing the lenses of the eyewear 100 and automatically cleaning the lenses of the eyewear 100 is described by taking the case where the initial state of the first lens 104 is at the use position D1 and the initial state of the second lens 105 is at the storage position D2 as an example. For example, when the user starts to use the eyewear 100, the first detection device 106A located on the first lens 104 may start to detect, automatically or based on the instruction of the control device 116, whether the foreign object is present on the surface of the first lens 104, and outputs the detection result to the control device 116. In the case where the first detection device 106A detects that there is no foreign object on the surface of the first lens 104, the first detection device 106A outputs the detection result to the control device 116. In the case where the control device 116 receives the detection result indicating that “there is no foreign object on the surface of the first lens 104” output by the first detection device 106A, or determines that “there is no foreign object on the surface of the first lens 104” based on the data returned by the first detection device 106A, the control device 116 sends a control signal to the driving mechanism 107 to allow the driving mechanism 107 to keep the current state, thereby allowing the first lens 104 to be continually located at the use position D1, and the user can continue to use the first lens 104.

For example, in the case where the first detection device 106A detects that there is a foreign object on the surface of the first lens 104, the first detection device 106A outputs the detection result to the control device 116. In the case where the control device 116 receives the detection result indicating that “there is a foreign object on the surface of the first lens 104” output by the first detection device 106A, or determines that “there is a foreign object on the surface of the first lens 104” based on the data returned by the first detection device 106A, the control device 116 sends a control signal to the driving mechanism 107 to drive the driving mechanism 107. After the driving mechanism 107 receives the control signal from the control device 116, the driving mechanism 107 may operate according to the operation mode described in the above embodiments to move the first lens 104, which is adhered with the foreign object, from the use position D1 to the storage position D2, and move the second lens 105, the surface of which is not adhered with a foreign object, from the storage position D2 to the use position D1 for the user to use.

For example, in the case where the first lens 104, the surface of which is adhered with the foreign object, moves to the storage position D2 in the storage box 103, the second detection device 106B located on the storage box 103 may start to detect, automatically or based on an instruction from the control device 116, the distance d in the Y direction between the first lens 104 and the cleaning brush 110, and output the detection result to the control device 116. For example, the second detection device 106B is further configured to detect whether a foreign object is present on the surface of the first lens 104 to further confirm the detection result of the first detection device 106A, or to confirm whether the first lens 104 is clean after the cleaning operation. After the control device 116 receives the information about the distance d transmitted by the second detection device 106B, the control device 116 compares the distance d with a predetermined distance stored in the memory in advance. In the case where the distance d is greater than the predetermined distance, the control device 116 drives the driving mechanism 107 to move the first lens 104 in the direction close to the cleaning brush 110. In the case where the distance d is less than the predetermined distance, the control device 116 drives the driving mechanism 107 to move the first lens 104 in the direction away from the cleaning brush 110. In the case where the distance d is equal to the predetermined distance, the control device 106 sends the control signals to the cleaning mechanism 108 and the cleaning motion mechanism 118, respectively. After the cleaning mechanism 108 receives the control signal, the cleaning brush putter 109 pushes the cleaning brush 110 in the direction close to the first lens 104 to allow the cleaning brush 110 to be in the extended state. After the cleaning motion mechanism 118 receives the control signal from the control device 116, the first driving device 111 of the cleaning motion mechanism 118 starts to operate to drive the cleaning brush 110 which is in the extended state. Under the driving of the first driving device 111, the cleaning brush 110 and the cleaning brush putter 109 reciprocates in the first guide rail 117 of the cleaning motion mechanism 118 along the X direction to clean the surface of the first lens 104. For example, in an example, the cleaning brush 110 is detachably disposed on the cleaning brush putter 109. In the case where the cleaning brush 110 is dirty or damaged, the cleaning brush 110 can be detached from the cleaning brush putter 109, so that the cleaning brush 110 can be cleaned, repaired or replaced, so as to realize the recycle utilization of the cleaning brush 110 and reduce the production cost.

It should be noted that, in the present embodiment, data such as the predetermined distance may be set in advance by the user and stored in the memory, or may be selected or set manually or automatically by the second detection device 106B according to the detected actual situation. The predetermined distance may be, for example, any suitable distance, such as 0.1 cm, 0.3 cm, 0.5 cm, or the like, which is not limited in the present embodiment. For example, in the case where the distance between the first lens 104 and the cleaning brush 110 in the Y direction is equal to the predetermined distance, the cleaning brush 110 can clean the surface of the first lens 104 in a wide range, so that the foreign object on the surface of the first lens 104 can be removed well.

For example, after the first lens 104 is cleaned, the first lens 104 is in the storage position D2 in the storage box 103. In order to prevent the first lens 104 from being contaminated once again in the storage box 103, for example, the second detection device 106B can further continuously detect the surface of the first lens 104 located at the storage position D2. In the case where the second detection device 106B detects that there is a foreign object on the surface of the first lens 104, the second detection device 106B sends the detection result to the control device 116, and the control device 116 sends control signals to the cleaning mechanism 108 and the cleaning motion mechanism 118, respectively. The cleaning mechanism 108 and the cleaning motion mechanism 118 can clean the first lens 104 again according to the operation mode described above to ensure that the surface of the first lens 104 is free of foreign objects.

For example, in the case where the foreign object is detected on the surface of the second lens 105 which is in the use position D1, based on the cooperation of the control device 116 and the driving mechanism 107, the first lens 104 moves from the storage position D2 to the use position D1, the second lens 105 moves from the use position D1 to the storage position D2, and the second lens 105 is cleaned, thereby performing the above operations in a cycle.

It should be noted that, for the purpose of clarity, the drawings do not illustrate the entire structure of the eyewear 100. In order to realize the necessary functions of the eyewear, those skilled in the art may set other structures not illustrated according to the application scenario, which is not limited in the present disclosure.

In at least one embodiment of the present disclosure, the first lens 104, the second lens 105, the driving mechanism 107, the control device 116, the first detection device 106A, and the like cooperate with each other to form the eyewear 100. The eyewear 100 can continuously detect whether there is a foreign object on the surfaces of the first lens 104 and the second lens 105 and automatically replace the spare lens according to the detection result, so that the lens at the use position D1 is a lens with a clean surface and no foreign object thereon. Furthermore, in at least one example, structures such as the second detection device 106B, the cleaning mechanism 108, and the cleaning motion mechanism 118 are also cooperated to enable the eyewear 100 to clean the surface of the lens in the storage box 103. The eyewear 100 provided in the present embodiment does not require the user to manually replace dirty lenses or does not require additional person to replace dirty lenses. The eyewear 100 can automatically replace lenses, and can further clean the foreign object on the surface of the lenses in the storage box 103 as required. The eyewear 100 can save the manpower cost, be beneficial to the user to concentrate attention, and improve the work efficiency of the user.

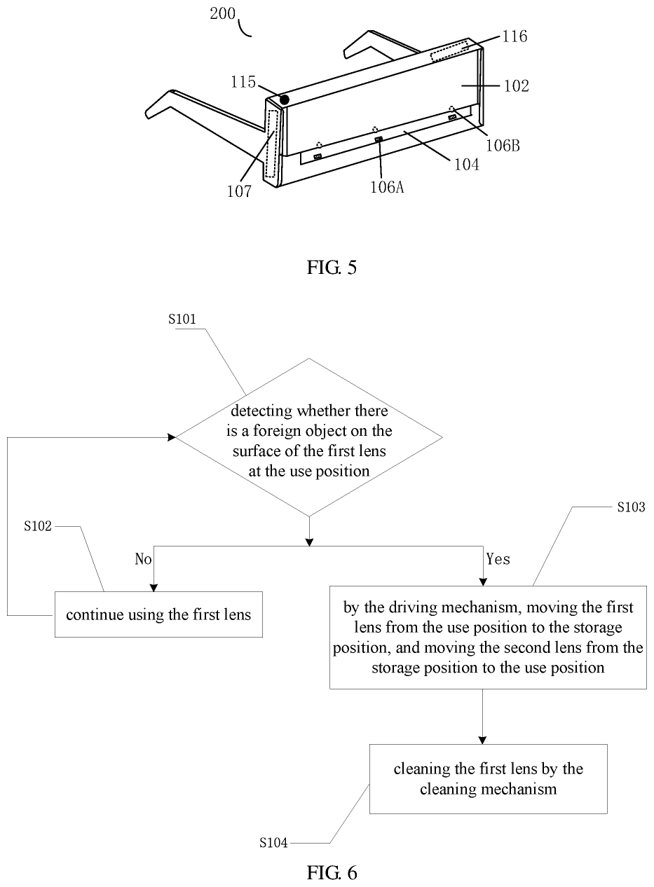

FIG. 5 is a schematic structural diagram of an eyewear 200 according to another embodiment. As illustrated in FIG. 5, in addition to the number of the lenses, the structure of the eyewear 200 in this embodiment may be basically the same as the structure of the eyewear 100 described in FIG. 1 and FIG. 2.

As illustrated in FIG. 5, the eyewear 200 includes a lens 104, and the driving mechanism 107 is configured to move the lens 104 from the use position D1 to the storage position D2 or move the lens 104 from the storage position D2 to the use position D1. The first detection device 106A is disposed on the surface of the lens 104 and is configured to continuously detect whether a foreign object is present on the surface of the lens 104.

For example, in the case where the first detection device 106A detects that there is a foreign object on the surface of the lens 104, the first detection device 106A outputs the detection result to the control device 116. After the control device 116 receives the detection result from the first detection device 106A, the control device 116 sends a control signal to the driving mechanism 107 to drive the driving mechanism 107. After the driving mechanism 107 receives the control signal from the control device 116, the driving mechanism 107 may operate according to the operation mode described in the above embodiments to enable the lens 104 to move from the use position D1 to the storage position D2. The control device 116 can adjust the distance in the Y direction between the lens 104 and the cleaning brush 110 based on the detection result of the second detection device 106B, so that the distance in the Y direction between the lens 104 and the cleaning brush 110 reaches the predetermined distance. The cleaning mechanism 108 can clean the surface of the lens 104 based on the operation mode described above to clean the foreign object on the surface of the lens 104. After the lens 104 is cleaned by the cleaning mechanism 108, the second detection device 106B detects the surface of the lens 104 to confirm that there is no foreign object on the surface of the lens 104. The second detection device 106B outputs the detection result to the control device 116. In the case where the control device 116 receives the detection result indicating that “there is no foreign object on the surface of the lens 104”, sent by the second detection device 106B, the control device 116 sends the control signal to the driving mechanism 107 to drive the driving mechanism 107. After the driving mechanism 107 receives the control signal from the control device 116, the driving mechanism 107 moves the lens 104 from the storage position D1 to the use position D2 for the user to continue use.

The eyewear 200 can continuously detect the surface of the lens 104 and automatically clean the surface of the lens according to the detection result. The eyewear 200 does not require the user to manually replace the dirty lens or require additional person to replace the dirty lens, thereby saving the manpower cost, being beneficial to the user to concentrate attention, and improving the work efficiency of the user. In addition, because the eyewear includes one lens 104, the weight of the eyewear 200 can be reduced to a certain extent, thereby allowing the eyewear 200 lighter as a whole, and improving the wearing comfort of the user.

In another embodiment, the eyewear 100 may not include the first detection device 106A configured to detect whether there is a foreign object on the surface of the lens which is at the use position, and the user requests replacement or cleaning of the lens through a wired control switch or a wirelessly control switch (not illustrated) that is in signal connection with the control device 116. When the control device 116 receives the request, the control device 116 sends the control signal to the driving mechanism 107 to enable the driving mechanism 107 to drive the lens for replacement or cleaning work.

At least one embodiment of the present disclosure further provides an electronic device, which includes any one of the eyewear described above. The electronic device may be, for example, any product or component that includes the eyewear or is used in conjunction with the eyewear, such as a detection device, a display device, or the like. For the technical effects of the electronic device, reference may be made to the technical effects of the eyewear described in the above embodiments, and details are not described herein again.

At least one embodiment of the present disclosure further provides a method for operating an eyewear, the method can be applied to, for example, the eyewear provided by at least one of the above embodiments, and the present embodiment is described by taking the eyewear 100 illustrated in FIG. 2 as an example. FIG. 6 is a flowchart of a method for operating an eyewear according to an embodiment of the present disclosure. As illustrated in FIG. 6, the method for operating the eyewear includes following steps.

Step S101: detecting whether there is a foreign object on the surface of the first lens at the use position, in case of no, going to step S102; in case of yes, going to step S103.

For example, the first detection device 106A is adopted to detect whether a foreign object exists on the surface of the first lens 104 which is at the use position D1. The foreign objects here include, but are not limited to, debris, dust, particles, blood stains, smudges, fingerprints, droplets and other objects. The object on the lens may be considered as the foreign object as long as the object on the lens affects the normal use of the user or has adverse effects on the use effect of the user.

Step S102: continue using the first lens.

For example, in the case where the first detection device 106A detects that there is no foreign object on the surface of the first lens 104, the first detection device 106A outputs the detection result to the control device 116. In the case where the control device 116 receives the detection result indicating that “there is no foreign object on the surface of the first lens 104” output by the first detection device 106A, or determines that “there is no foreign object on the surface of the first lens 104” based on the data returned by the first detection device 106A, the control device 116 sends the control signal to the driving mechanism 107, and the driving mechanism 107 outputs a corresponding instruction according to the received control signal, thereby allowing the first lens 104 to maintain at the use position D1 for the user to use.

Step S103: by the driving mechanism, moving the first lens from the use position to the storage position, and moving the second lens from the storage position to the use position.

For example, in the case where the first detection device 106A detects that there is a foreign object on the surface of the first lens 104, the first detection device 106A outputs the detection result to the control device 116. In the case where the control device 116 receives the detection result indicating that “there is a foreign object on the surface of the first lens 104” output by the first detection device 106A, or determines that “there is a foreign object on the surface of the first lens 104” based on the data returned by the first detection device 106A, the control device 116 sends a control signal to the driving mechanism 107 to drive the driving mechanism 107. After the driving mechanism 107 receives the control signal from the control device 116, the driving mechanism 107 may operate according to the operation mode described in the above embodiments to move the first lens 104, which is adhered with the foreign object, from the use position D1 to the storage position D2, and move the second lens 105, the surface of which is not adhered with the foreign object, from the storage position D2 to the use position D1 for the user to use.

Step S104: cleaning the first lens by the cleaning mechanism.

For example, when the driving mechanism 107 moves the first lens 104 from the use position D1 to the storage position D2, the cleaning mechanism 108 may clean the surface of the first lens 104 in the manner described in the above embodiments, so as to clean the foreign object on the surface of the first lens 104.

In the case of no conflict, features in one embodiment or in different embodiments can be combined to obtain new embodiments.

What have been described above are merely exemplary embodiments of the present disclosure, and are not intended to limit the protection scope of the present disclosure, and the protection scope of the present disclosure is determined by the appended claims.

What is claimed is:

1. An eyewear, comprising a frame capable of being mounted with at least one lens, and a driving mechanism,
wherein a lower part of the frame is configured as a use position allowing the at least one lens to be in a use state, an upper part of the frame is configured as a storage position allowing the at least one lens to be in a storage state, and the driving mechanism is configured to drive the at least one lens to move between the use position and the storage position.

2. The eyewear according to claim 1, further comprising an eyewear cover, wherein the eyewear cover is on the upper part of the frame and forms a storage box having a storage space together with the frame, and the storage box is configured to accommodate the at least one lens at the storage position.

3. The eyewear according to claim 2, further comprising a cleaning mechanism, wherein the cleaning mechanism is in the storage box and is configured to clean the at least one lens accommodated in the storage box.

4. The eyewear according to claim 3, wherein the cleaning mechanism comprises a cleaning brush and a cleaning brush putter,
the cleaning brush putter is configured to enable the cleaning brush to be in a retracted state, or to be in an extended state to perform a cleaning operation, and the cleaning brush is configured to clean a surface of the at least one lens accommodated in the storage box.

5. The eyewear according to claim 4, wherein a first side of the eyewear cover is provided with a cleaning motion mechanism, and the cleaning mechanism is configured to reciprocate on the cleaning motion mechanism.

6. The eyewear according to claim 5, wherein the cleaning motion mechanism comprises a first guide rail and a first driving device, and the first driving device is configured to drive the cleaning brush and the cleaning brush putter to reciprocate on the first guide rail.

7. The eyewear according to claim 6, further comprising a detection device, wherein the detection device is configured to detect whether there is a foreign object on a surface of the at least one lens.

8. The eyewear according to claim 7, wherein the detection device comprises an infrared detection device.

9. The eyewear according to claim 7, wherein the detection device comprises a camera.

10. The eyewear according to claim 1, wherein the driving mechanism comprises at least one second guide rail and a second driving device,
the at least one lens is able to slide along the second guide rail to move from the use position to the storage position or from the storage position to the use position, and
the second driving device is configured to drive the at least one lens to slide on the second guide rail.

11. The eyewear according to claim 1, wherein the driving mechanism comprises an association mechanism, the frame is mounted with two lenses, and the association mechanism is configured to relatively and associatively drive the two lenses, which are connected to the association mechanism, so as to enable the two lenses to perform a relative movement.

12. The eyewear according to claim 11, wherein the association mechanism comprises a linear reciprocating motion mechanism.

13. The eyewear according to claim 1, further comprising a control device, wherein the control device is configured to control the driving mechanism to move the at least one lens.

14. The eyewear according to claim 1, wherein the frame is mounted with at least two lenses.

15. An electronic device, comprising the eyewear according to claim 1.

16. An electronic device, comprising the eyewear according to claim 2.

17. The eyewear according to claim 2, further comprising a control device, wherein the control device is configured to control the driving mechanism to move the at least one lens.

18. The eyewear according to claim 3, further comprising a control device, wherein the control device is configured to control the driving mechanism to move the at least one lens.

19. The eyewear according to claim 2, wherein the frame is mounted with at least two lenses.

20. The eyewear according to claim 3, wherein the frame is mounted with at least two lenses.
